(19) United States
(12) Patent Application Publication
(10) Pub. No.: US 2022/0353217 A1
(43) Pub. Date: Nov. 3, 2022

(54) ONLINE MEETING PHONE AND CHAT CONNECTIVITY

(71) Applicant: Microsoft Technology Licensing, LLC, Redmond, WA (US)

(72) Inventors: Nakul MADAAN, Prague (CZ); Neeraj Kumar Jain, Prague (CZ); Dominic Roedel, Prague (CZ)

(21) Appl. No.: 17/243,948

(22) Filed: Apr. 29, 2021

(51) Int. Cl. H04L 12/58; H04M 3/56

(52) U.S. Cl. CPC H04L 51/046; H04M 3/567; H04L 51/38; H04M 2203/5054; H04M 2207/203; H04M 2203/652; H04M 2203/651

(57) ABSTRACT

Systems and methods may be used for connecting a caller to an online chat function of a meeting via messaging. A method may include identifying a user device connected to an online conferencing meeting via an audio connection, and associating the user device to a chat portion of the online conferencing meeting. The method may include receiving a chat message in the chat portion of the online conferencing meeting and sending a text message, including the chat message, to the user device.

### BACKGROUND

Current online conferencing solutions in the market allow participants who join the online conference to join via a native application (e.g., Desktop/Windows/Mac/iOS/Android etc.) or via a website. These online conferencing solutions allow users to conduct meetings with audio, video, image, text, chat, etc. Some online conferencing solutions require an application or internet connection to use rich experience features, such as chat, tagging, file sharing, or the like.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example system diagram for providing chat messages to an audio participant in an online meeting according to some examples of the present disclosure.

FIGS. 2-4 illustrate example user interfaces for chat and messaging capabilities according to some examples of the present disclosure.

FIG. 5 illustrates a flowchart of a technique for providing chat messages to an audio participant in an online meeting according to some examples of the present disclosure.

FIG. 6 illustrates a flowchart of a technique for connecting a caller to an online chat function of a meeting via text messaging according to some examples of the present disclosure.

FIG. 7 illustrates a block diagram of an example machine which may implement one or more of the techniques discussed herein according to some examples of the present disclosure.

### DETAILED DESCRIPTION

Systems and methods for connecting a user to a chat portion of a meeting (e.g., an online meeting, such as a video conferencing meeting) are described herein. In an example, these systems and methods may be used to add chat features to a user connected via only an audio connection to the meeting, for example when the user does not have chat accessibility. In an example, a meeting participant joins an online conference (e.g., a video conference with concurrent chat function) via a telephony network (PSTN, etc.) or other audio channel connection. The participant may automatically or manually (e.g., configurable at the user-level, by default, or by the meeting organizer for a given meeting) join the chat or messaging modality of the meeting using a separate messaging channel, such as short message service (SMS) or multimedia messaging service (MMS). The user may connect to the messaging modality using a same device or phone number as the audio connection.

A text message may be used to allow a user to receive chat messages from an online meeting. In an example, a single device is used by a participant to join an online conference by phone (e.g., an audio only connection) and also receive chat messages via text message (e.g., SMS). In some examples, the audio and text connections may be accessed without an internet connection at a device (or without using an internet connection of the device). In an example, the device may access the online meeting without using a dedicated client or without accessing a website. The audio and text connections may be over a single channel (e.g., a telephony channel), or may use different channels. A text message may include text, emoticons, emojis, images, files, etc.

A chat portion of the online meeting may be sent to the device based on an initiation. The initiation may be configured by a user of the device, by a host or user of the online meeting (e.g., a user connected via a client, website, or other internet-based connection), by a default or set configuration parameter of the online meeting (e.g., a default client-based rule), or the like. The initiation may occur automatically when the device is connected to an audio portion of the online meeting. In another example, the initiation may occur based on a text message sent by the device, which may require a pre-determined command, such as “join meeting.” In this example, the text message may include an identifier, an initiation request, a username, a password, etc. In yet another example, the initiation may occur based on an automated message sent to the device, which asks the user for confirmation to connect to the chat portion via text messaging. The user may respond with a text message indicating acceptance of the connection to the chat portion. The device may be connected when the response is received (e.g., at a server).

Security measures may be used to ensure the device (or user of the device) is authorized to access the chat portion of the online meeting. For example, a password or meeting identifier may be required. In another example, the phone number used to connect to the audio portion of the online meeting may be used to authorize the user or device. In an example, the initiation may use or require a password or a meeting identifier. In an example, a message sent from the device to receive messages may include a meeting bridge number of the online meeting. To join the meeting chat, the text message my specify a unique conference identifier of the meeting.

The chat portion of the online meeting may display an indication that the user who joined via phone is connected and is to receive chat messages. The messages may be sent to the device by an online conferencing server using a number that is unique to the online meeting in progress, a number unique to the online conferencing server, a number unique to a host of the meeting, a number unique to the client (e.g., a company operating the client, app, or website), or the like.

In an example, the user may send an SMS from the device using an at-mention format, (e.g., “@Sarah”). In this example, the receiving online conferencing system may parse the SMS and interpret the at-mention to tag the person (e.g., Sarah) in the meeting chat portion similar to or the same as for users of a native client, app, or website. A user connected to the chat portion directly (e.g., via a client, a website, etc.) may tag the user connected via the audio and text message connections. For example, an at-mention may include the phone number of the user, or a representation of the user may be selected using a touch or mouse input. The at-mention may be converted and sent in the text message via plain text, or with optional formatting, such as including additional text (e.g., “you were tagged in this comment”), or the like.

In another example, the at-mention may be used to convert the text message to a direct chat message to the tagged participant. For example, a text message from the user that includes “@Sarah” may be used to send a chat message only to “Sarah”, and in an example, not a public message in the chat portion to all participants. In this example, the at-mention text (e.g., “@Sarah”) may be removed, since the recipient is the only person receiving the message. Multiple at-mentions may be made, which may be sent as a small group message (e.g., visible to all tagged and the sender) or with multiple at-mentions, a public message may be sent with each participant tagged.

In an example, a network connection or internet connection is not available or does not exist at the user device. When a network connection (e.g., internet) is available, the device may convert a text message to a different format before sending. In this example, the device converts the text message to a chat message or a chat message to a text message locally. The device may send the chat message using the network connection (e.g., directly to a server controlling the online meeting, rather than via an intermediary, such as a gateway server).

The systems and methods described herein solve technical problems related to accessing chat messages in an online meeting when a device is connected only via an audio connection. One example technical solution described herein provides for sending chat messages over a message connection, such as SMS. Another example technical solution described herein provides for converting between chat messages and text messages for connecting the device to a chat portion of an online meeting.

Current online conferencing solutions allow participants who join the online conference to have a full-fledged, feature rich experiences, including the ability to chat in the meeting with meeting participants only when connecting via a native client (e.g., a desktop app, a mobile app, or a website etc.). However, many people, especially in the United States, tend to connect to meetings via phone (e.g., audio only) for cultural or connectivity reasons. These rich experiences are not available when the participant joins the meeting via a telephony network (e.g., PSTN or phone dial-in) or other audio only connection. In this example, the participant joins a meeting by dialing-in a phone number, for example, such as with a bridge number and a meeting identifier. Once accepted, the participant joins the meeting via audio only. This participant is then limited to only sending or receiving audio in the online meeting. The participant, by the virtue of being joined via a telephony network, and not via internet, may not be able to consume any other rich modalities, most notable of them being a chat feature. In some examples, a participant may not be able to access a network connection. For example, participants who are on the go (as in travelling), have bad or no internet network available, do not have access to native apps (e.g., are not able to download or install due to security or company policy, device space or capabilities, or location, such as country-level limitations), or do not have a meeting link to join the meeting. In a lot of industries, joining via phone is quite a common and mainstream way to join meetings.

The systems and methods described herein provide the audio-only connected participants with the ability to receive and send messages in an ongoing online meeting by using messaging capabilities of the device (e.g., SMS) or a second device. When a user joins a meeting via phone dial-in, the user may automatically or manually (e.g., as configured at the user-level, by the meeting organizer for a given meeting, by the native client by default, or the like) join the chat and messaging modality of the meeting. By using a messaging-based mechanism as described herein, the user may join the meeting chat portion even though the user is initially only connected to the meeting via an audio connection (e.g., PSTN telephony network). Participants may read incoming messages and send messages in the meeting chat using the phone network without any internet connection or without any availability of a native app. This greatly enhances the meeting experience for many daily users who join via phone. In an example, a message may be sent to a device via email (e.g., as a ‘text message’), such as instead of or in addition to an SMS, MMS, etc. When sent as an email, individual messages may be sent or a digest may be sent (e.g., every few minutes or at the end of the meeting).

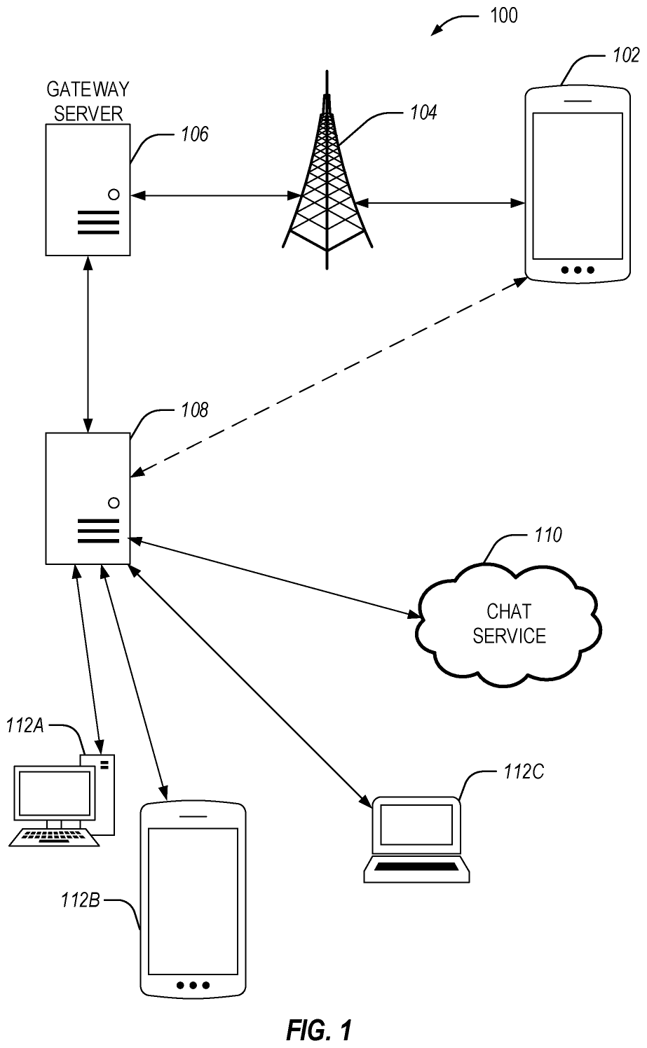

FIG. 1 illustrates an example system diagram 100 for providing chat messages to an audio participant in an online meeting according to some examples of the present disclosure. The diagram 100 illustrates and example connection setup, but may be modified with additional or fewer components. The diagram 100 includes a user device 102 connected via an audio only connection to an online meeting. In an example, the online meeting is hosted by a server 108. The audio connection from the device 102 may connect via an antenna 104 (e.g., for a cellular connection), via a landline connection, or the like. The audio connection may use a gateway server 106 to connect the device 102 to the server 108. The gateway server 106 may include a device that communicates or acts as an intermediary between a telephony network (e.g., represented by antenna 104, which may be a 3G, 4G, 5G, etc. antenna) and a server (e.g., the server 108). The gateway server 106 may include an exchange server, a trunking server, such as for a private branch exchange (PBX), etc. In another example, the device 102 may optionally connect to the server 108 using a network connection (e.g., when the network connection is available at the device 102 but not necessarily used to connect to the online meeting initially, such as when the device 102 uses a dial-in function to connect).

The device 102 may connect to the online meeting using various connection protocols or techniques such as PSTN for audio and SMS (which may also be PSTN) for text, VoIP via internet and PSTN SMS for text, VoIP via internet and messages via a designated app also through internet, etc.

The server 108 may host the online meeting by connecting participant devices (e.g., 112A, 112B, 112C, etc.) using an audio connection, a client-based connection (e.g., a desktop app, a mobile app, a website, etc.), or the like. The server 108 may use a chat service 110, which may operate in the cloud, to manage the chat portion of the online meeting. The server 108 or the chat service 110 may include a messaging database to store chats sent in the chat portion of the online meeting. The server 108 may connect the device 102 to the online meeting using the audio only connection. The server 108 may send messages from the chat portion of the online meeting to the device 102 (e.g., via the gateway server 106). The server 108 may send chat messages to the various participants using various connections, such as the native client for devices 112A-112C, and a text message to the device 102.

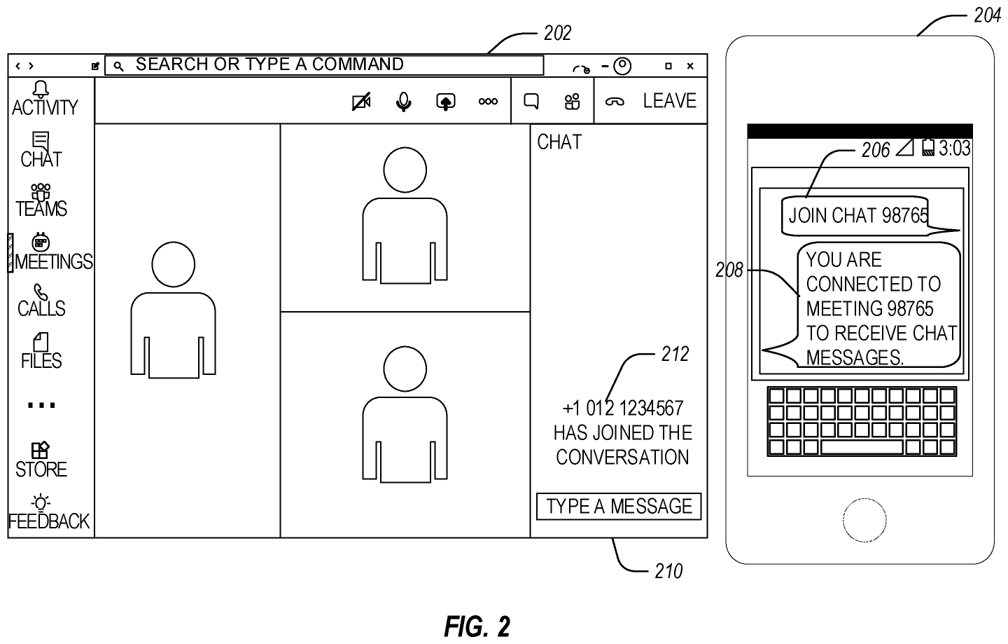

FIGS. 2-4 illustrate example user interfaces for chat and messaging capabilities according to some examples of the present disclosure.

FIG. 2 shows a user interface where a user device 204 is connecting or attempting to connect to a chat portion 210 of an online meeting 202, with the user device 204 already connected to an audio portion of the online meeting 202. The online meeting 202 is shown in FIG. 2 with the user device 204 for illustrative purposes. The user device 204 may be a phone, such as a cell phone. The user device 204 may be connected or may connect to the online meeting 202 via an audio connection (e.g., a phone call).

The user device 204 is shown with a text message user interface including example text messages, which may be exchanged with a server hosting the online meeting 202. A first text message 206 is sent from the user device 204 to join the chat portion 210 of the online meeting 202. The text message 206 may include a meeting identifier (e.g., “98765”) and a keyword or key phrase (e.g., “join” or “join chat”). The text message 206 may include other information in other examples, such as a bridge number, a password, etc. Metadata may be sent with the text message 206 to the server, such as a phone number of the user device 204, a timestamp, a user credential, etc. In response, the server may send a text message 208 to the user device 204. The text message 208 may not be displayed in the online meeting 202 in an example. The text message 208 indicates that the user device 204 is now connected to the chat portion 210 of the online meeting 202 to receive or send messages via text messages. A related chat message 212 may be displayed in the chat portion 210 of the online meeting. The chat message 212 may indicate that the user device 204 has connected to the chat portion 210, such as by displaying a phone number (e.g., +1 012 1234567) corresponding to the user device 204.

Although FIG. 2 shows the text message 206 being sent by the user device 204 to connect to the online meeting 202, in other examples, the user device 204 may be connected automatically when connecting to an audio portion of the online meeting 202. In another example, in response to the user device 204 connecting via audio to the online meeting 202, a host server may send a text message to the user device 204 asking whether the user wants to connect to the chat portion 210 of the online meeting 202 via text messaging. The user may send a response confirming the connection, and may be connected. The technique for connecting the user device 204 to the chat portion 210 of the online meeting may be configured by the user of the user device 204, a host participant of the online meeting 202, a default configuration for online meetings (e.g., set by a company hosting the server for the online meeting 202), a configuration set for a company or participant involved in the online meeting 202, or the like.

Text messages received by the user device 204 from chat messages sent in the chat portion 210 of the online meeting 202 may include text, emoticons, emojis, images, files, or the like. Text messages may include a name of a sender (in the chat portion 210), a timestamp, tagging information, or other details. In an example, text messages received by the user device 204 may be sent from a unique number, such as a number corresponding to the server hosting the online meeting 202, a number unique to the online meeting 202, a number corresponding to a host of the online meeting 202, or the like.

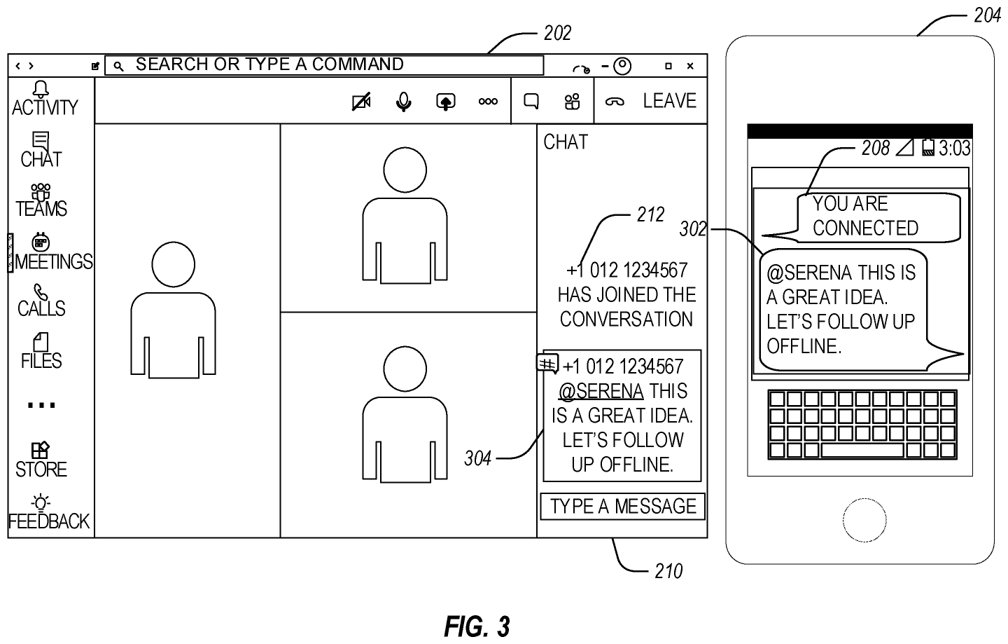

FIG. 3 shows a message 302 sent from the user device 204 to the chat portion 210 of the online meeting 202, the message 302 including a tag. The tag is displayed in the chat portion 210 with an additional feature in chat message 304. The additional feature may be used to alert the tagged user (e.g., “@Serena”). The message 302 is sent via text message from the user device 204 to a server hosting the online meeting 202. The server then converts the text message to a chat message, which is then displayed in the chat portion 210 as chat message 304. An indication may be provided in the chat portion of an identifying detail of the user device 204 (e.g., a phone number “+1 012 1234567”, a name, etc.).

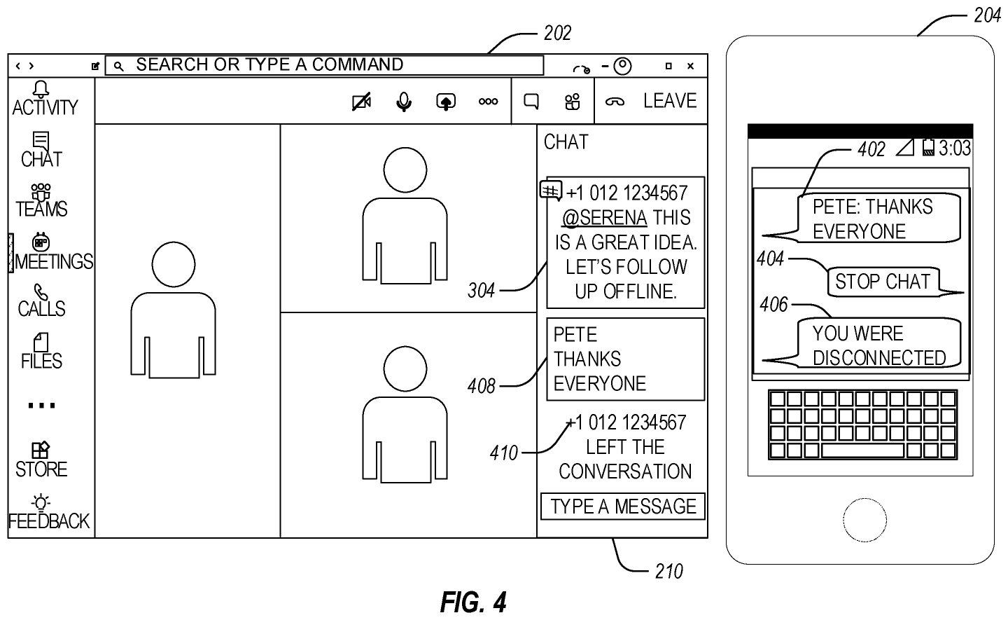

FIG. 4 shows messages sent to the user device 204 from the chat portion 202. FIG. 4 also shows a ‘stop chat’ message 404 from the user device 204, indicating that the user wishes to no longer receive messages from the chat portion 210 of the online meeting 202. A message sent from “Pete” is shown in the chat portion 210 as message 408 and shown on the user device 204 as message 402.

To stop the messages, the user may reply to previous messages (or an initial connection confirmation message). The messages from the chat portion 210 may be stopped by sending the stop message 404. The stop message 404 may include a predetermined command, such as “STOP CHAT” to disconnect from the chat portion 210 of the online meeting 202. In an example, the messages from the chat portion 210 may be stopped when the user device 204 disconnects the audio portion from the online meeting 202. In an example, the user device 204 may be disconnected from receiving chat messages via text based on a selection by a host of the online meeting 202, or automatically when the online meeting 202 ends.

In response to the stop message 404 (or other disconnection from receiving messages from the chat portion 210), the user device 204 may receive a message 406 indicating that the user device 204 is disconnected from receiving messages posted to the chat portion 210. The audio connection of the user device 204 may be independent of this disconnection (e.g., may continue) or may be dependent (e.g., when one of the audio or text connections ends, the other may end automatically). In an example, an indication 410 may be posted to the chat portion 210 that the user device 204 has disconnected (e.g., by displaying a number or name associated with the user device 204 and indicating that the user has left the conversation).

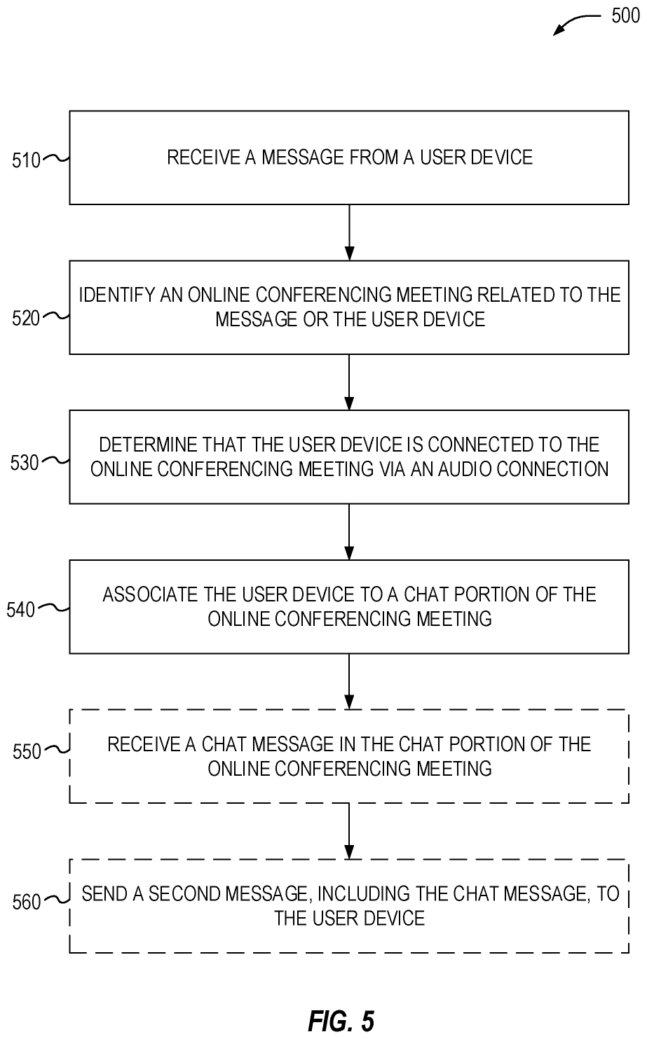

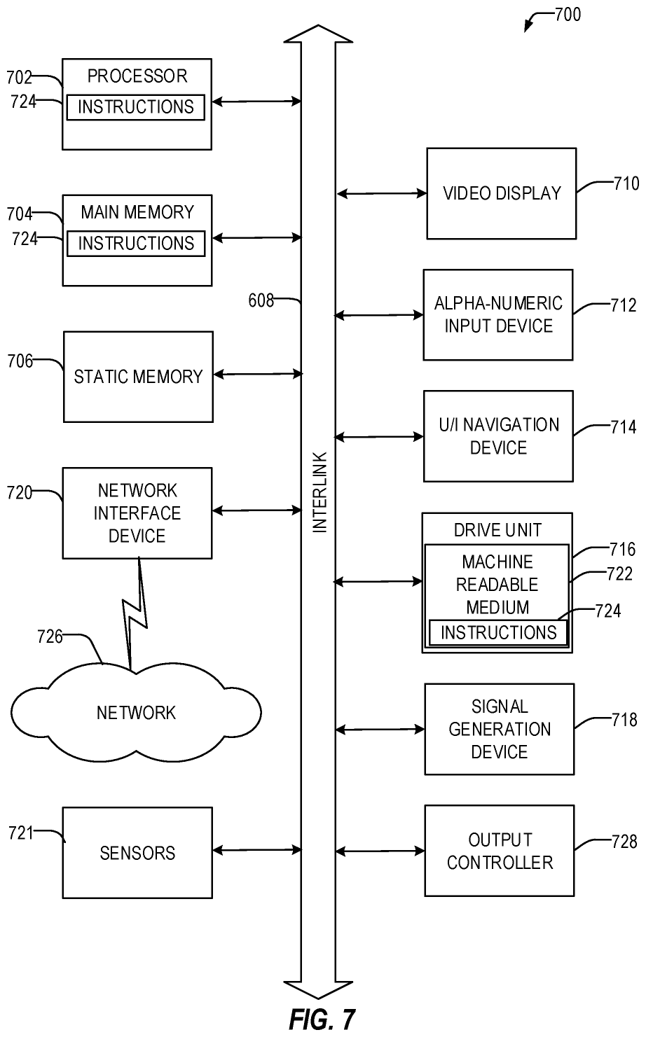

FIG. 5 illustrates a flowchart of a technique 500 for providing chat messages to an audio participant in an online meeting according to some examples of the present disclosure. The technique 500 may be performed using a processor or processors of a device, such as a computer, a laptop, a mobile device, or the like (e.g., as discussed in further detail below with respect to FIG. 1 or 7). For example, the technique 500 may be performed by a data processing system, such as a user device (e.g., a phone, a laptop, a desktop computer, etc.) or a server. The technique 500 may be used to connect a caller to an online chat function of a meeting via text messaging.

The technique 500 includes an operation 510 to receive a message from a user device. The message may be received at a server via a gateway server. The message may be a text message. In an example, the message includes a meeting identifier. The message may include a keyword or key phrase, such as ‘join’, ‘join meeting’, ‘connect’, ‘join chat’, ‘team chat’, or the like. The keyword or key phrase may identify a meeting, such as by a team name, a meeting name, a connection name, etc. The keyword or key phrase may be used to route the message to the server from the gateway server. The message may include a number, such as a bridge number, a meeting number, or the like. The meeting identifier may include a keyword or key phrase or a number. The online conferencing meeting may be a video meeting with chat functionality or an audio meeting with chat functionality.

A message may include a text message, such as an SMS or an MMS. The message may include a message via exchange server, an email, a message sent over a different channel than an audio call, or the like. A text message may include emoticons, emojis, images, etc.

In an example, a gateway server may include a device that communicates or acts as an intermediary between a telephony network and a server (e.g., the server performing the technique 500). The gateway server may include an exchange server, a trunking server, such as for a private branch exchange (PBX), etc.

The technique 500 includes an operation 520 to identify an online conferencing meeting related to the message or the user device. Operation 520 may occur at the server. In an example, the online conferencing meeting may correspond to the meeting identifier. The meeting identifier may include a bridge number, an identifier unique to the meeting, an identifier unique to the user, an identifier unique to both the meeting and the user (e.g., a one-time code), a password, etc. The meeting identifier may include a security feature, such as an RSA key or an authenticator application, two-factor authentication, or the like to ensure that the user is authorized to receive or send chat messages.

The technique 500 includes an operation 530 to determine that the user device is connected to the online conferencing meeting via an audio connection. The audio connection may include a connection over an audio channel. The audio channel may connect to the online conferencing meeting using the same gateway server used to forward the message, or may use a different gateway service (e.g., Global System for Mobile Communications (GSM) in Europe may have separate services, but in the U.S., the same service may be used). The user device may be connected to the online conferencing meeting via the audio connection without internet connectivity at the user device or without using an internet connection. In an example, the user device may be connected to the online conferencing meeting via the audio connection on a poor internet connection, such as one with a low bandwidth, high latency, or one or frequent disconnections. The user device may be connected to the online conferencing meeting via the audio connection without a video connection, without accessing a chat feature, or without using an application (e.g., a video conferencing meeting application, such as Teams® by Microsoft of Redmond, Wash.). In an example, the user device may use a native client, such as a mobile app, for a user interface, but without internet. In this example, the underlying connections may be via phone call and text message, but may be arranged on the user device to appear in the native client. In this example, the chat and call presentation on the native client may be seamless such that the user may not be aware that the network connect was lost or not active. The user may request or select to use this example mode, such as when the user is low on available cellular data, in a roaming area, etc.

The technique 500 includes an operation 540 to associate the user device to a chat portion of the online conferencing meeting. The association may be based on the message, the meeting identifier, or the audio connection. Operation 540 may include displaying an indicator, such as in a user interface corresponding to the online conferencing meeting (e.g., on a second user device) identifying that the user device can receive text messages via the chat portion. Operation 540 may include outputting the indicator for display from the server to be displayed.

The technique 500 includes an optional operation 550 to receive a chat message in the chat portion of the online conferencing meeting. Operation 550 may include receiving the chat message at the server from a chat service (e.g., run on a chat server or as a cloud service). The chat message may include text or other characters, an emoticon, an emoji, a file, an image, or the like. The text or other characters, the emoticon, the emoji, the file, the image, etc., may be sent to the user device (e.g., via the gateway server as a message).

The technique 500 includes an optional operation 560 to send a second message, including the chat message, to the user device. The second message may be sent from the server via the gateway server.

In an example, a message may be sent to or from the user device automatically when the user device is connected to the online conferencing meeting via the audio connection (e.g., on connection, after connection, in response to a user selection of a number on the user device during the audio connection, etc.). The message may be sent to or from the user device using a phone number, and the phone number may be used for the audio connection. Associating the user device to the chat portion may include using the phone number (e.g., identifying that the phone number is connected to the audio connection, and that the message was received using the phone number).

The technique 500 may include an operation to receive a third text message from the user device. In response, the technique 500 may include propagating text from the third text message to the chat portion of the online conferencing meeting. In an example, the technique 500 includes converting a text string in the third text message to a tag. The tag may be displayed in the chat portion of the online conferencing meeting, in an example. The technique 500 may include an operation to receive a subsequent text message from the user device requesting the chat messages stop. In response, the technique 500 may include stopping sending future chat messages received in the chat portion of the online conferencing meeting. In an example, after the user device is disconnected from the audio connection, future chat messages may not be sent.

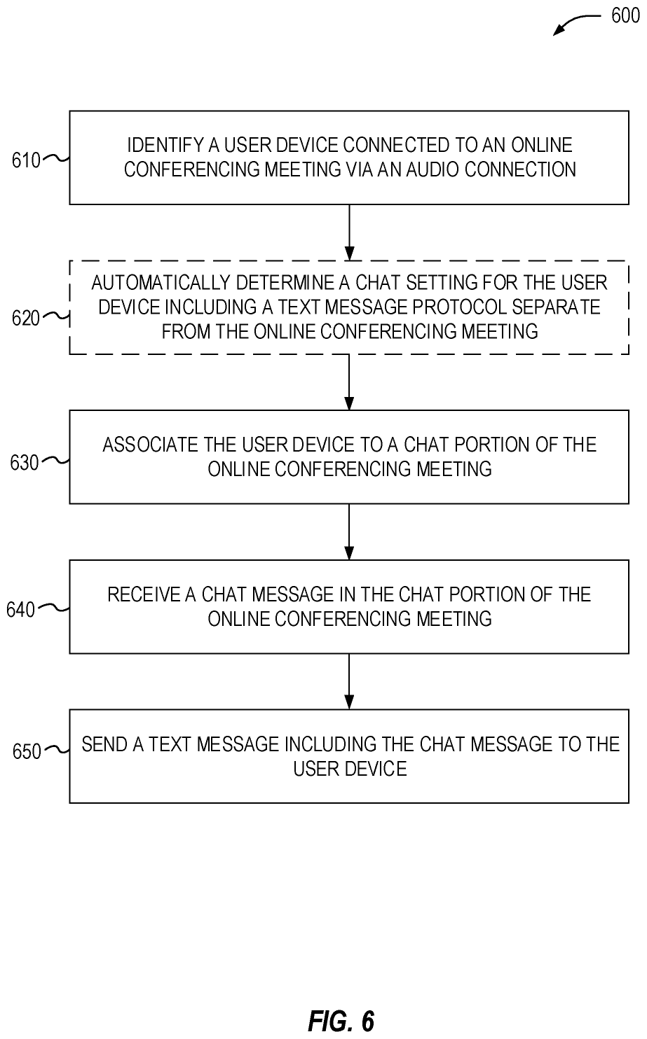

FIG. 6 illustrates a flowchart of a technique 600 for connecting a caller to an online chat function of a meeting via text messaging according to some examples of the present disclosure. The technique 600 may be performed using a processor or processors of a device, such as a computer, a laptop, a mobile device, or the like (e.g., as discussed in further detail below with respect to FIG. 1 or 7). For example, the technique 600 may be performed by a data processing system, such as a server.

The technique 600 includes an operation 610 to identify a user device connected to a online conferencing meeting via an audio connection. In an example, the user device is connected to the online conferencing meeting via the audio connection without internet connectivity at the user device. In another example, the user device may have internet connectivity, but does not use an app or internet connection for the audio connection. In an example, the online conferencing meeting may include a video conferencing meeting or an audio conferencing meeting.

The technique 600 includes an optional operation 620 to automatically determine a chat setting for the user device including a text service separate from the online conferencing meeting. In an example, the chat setting is configured by a user of the user device or by a host of the online conferencing meeting. In another example, the chat setting is configured for the meeting, such as based on a default setting, a corporate setting, a school setting, or the like. The text service may include short message service (SMS) or Multimedia Messaging Service (MMS) over Public Switched Telephone Network (PSTN), a text messaging service provided via an app outside the online conferencing meeting, a text message sent over Session Initiation Protocol (SIP), such as an instant message, or the like.

The technique 600 includes an operation 630 to associate the user device to a chat portion of the online conferencing meeting. Operation 630 may include associating the user device in response to the user device connecting to the online conferencing meeting via the audio connection or in response to a user selection of a number on the user device during the audio connection. Operation 630 may include displaying an indicator, in a user interface corresponding to the online conferencing meeting, identifying the user device can receive text messages via the chat portion. Associating the user device may include sending a confirmation request text message to the user device or audibly requesting that the user device confirm access to text messaging (e.g., audio stating “press 1 to accept text messages”). The user device may receive the confirmation request text and a response may be sent from the user device confirming access.

The technique 600 includes an operation 640 to receive a chat message in the chat portion of the online conferencing meeting. The technique 600 includes an operation 650 to send a text message including the chat message to the user device. In an example, the chat message may include an emoji, a file, or an image. The technique 600 may include sending the emoji, the file, or the image to the user device in the text message. The text message may be sent to the user device using a phone number, and the phone number may be the same number that is used by the user device for the audio connection.

The technique 600 may include an operation to receive a second text message from the user device, and in response, propagate text from the second text message to the chat portion of the online conferencing meeting. This operation may include converting a text string in the second text message to a tag, and displaying the tag in the chat portion of the online conferencing meeting. This operation may include causing the text from the second text message to be displayed in a user interface implementation of the chat portion on an attendee device that is connected to the chat portion of the online conferencing meeting. The technique 600 may include receiving a subsequent text message from the user device requesting the chat messages stop, and in response, stopping sending future chat messages received in the chat portion of the online conferencing meeting.

FIG. 7 illustrates a block diagram of an example machine 700 which may implement one or more of the techniques (e.g., methodologies) discussed herein according to some examples of the present disclosure. In alternative embodiments, the machine 700 may operate as a standalone device or may be connected (e.g., networked) to other machines. In a networked deployment, the machine 700 may operate in the capacity of a server machine, a client machine, or both in server-client network environments. The machine 700 may be configured to perform the methods of FIG. 5 or 6. In an example, the machine 700 may act as a peer machine in peer-to-peer (P2P) (or other distributed) network environment. The machine 700 may be a user device, a remote device, a second remote device or other device which may take the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms (hereinafter “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB)), parallel, or other wired or wireless (e.g., infrared (IR), near field communication (NFC), High-Definition Multimedia Interface (HDMI), etc.) connection to communicate or control one or more peripheral devices (e.g., a printer, card reader, etc.).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may be non-transitory machine-readable media. In some examples, machine readable media may include machine readable media that is not a transitory propagating signal.

The instructions 724 may further be transmitted or received over a communications network 726 using a transmission medium via the network interface device 720. The machine 700 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. In some examples, the network interface device 720 may wirelessly communicate using Multiple User MIMO techniques.

Example 1 is a method for connecting a caller to an online chat function of a meeting via text messaging, the method comprising: receiving, at a server via a gateway server, a text message from a user device, the text message including a meeting identifier; identifying, at the server, a video conferencing meeting corresponding to the meeting identifier; determining that the user device is connected to the video conferencing meeting via an audio connection; associating the user device to a chat portion of the video conferencing meeting based on the text message, the meeting identifier, and the audio connection; receiving, at the server from a chat service, a chat message in the chat portion of the video conferencing meeting; and sending, from the server via the gateway server, a second text message, including the chat message, to the user device.

In Example 2, the subject matter of Example 1 includes, wherein the text message includes a keyword or key phrase.

In Example 3, the subject matter of Examples 1-2 includes, wherein the user device is connected to the video conferencing meeting via the audio connection without internet connectivity at the user device.

In Example 4, the subject matter of Examples 1-3 includes, receiving a third text message from the user device, and in response, propagating text from the third text message to the chat portion of the video conferencing meeting.

In Example 5, the subject matter of Example 4 includes, converting a text string in the third text message to a tag, and displaying the tag in the chat portion of the video conferencing meeting.

In Example 6, the subject matter of Examples 1-5 includes, wherein associating the user device to the chat portion includes displaying an indicator, in a user interface corresponding to the video conferencing meeting, identifying the user device can receive text messages via the chat portion.

In Example 7, the subject matter of Examples 1-6 includes, wherein the chat message includes an emoji, a file, or an image, and further comprising, sending the emoji, the file, or the image to the user device.

In Example 8, the subject matter of Examples 1-7 includes, receiving a subsequent text message from the user device requesting the chat messages stop, and in response, stopping sending future chat messages received in the chat portion of the video conferencing meeting.

In Example 9, the subject matter of Examples 1-8 includes, wherein the text message is sent from the user device automatically when the user device is connected to the video conferencing meeting via the audio connection.

In Example 10, the subject matter of Examples 1-9 includes, wherein the text message is sent from the user device using a phone number, and wherein the phone number is used for the audio connection.

Example 11 is a system for connecting a caller to an online chat function of a meeting via text messaging, the system comprising: a gateway server; a server including a processor and memory, the memory including instructions, which when executed by the processor, cause the processor to: receive, via the gateway server, a text message from a user device, the text message including a meeting identifier; identify a video conferencing meeting corresponding to the meeting identifier; determine that the user device is connected to the video conferencing meeting via an audio connection; associate the user device to a chat portion of the video conferencing meeting based on the text message, the meeting identifier, and the audio connection; receive, from a chat service, a chat message in the chat portion of the video conferencing meeting; and send, via the gateway server, a second text message, including the chat message, to the user device.

In Example 12, the subject matter of Example 11 includes, wherein the text message includes a keyword or key phrase.

In Example 13, the subject matter of Examples 11-12 includes, wherein the user device is connected to the video conferencing meeting via the audio connection without internet connectivity at the user device.

In Example 14, the subject matter of Examples 11-13 includes, wherein the instructions further cause the processor to receive a third text message from the user device, and in response, propagate text from the third text message to the chat portion of the video conferencing meeting.

In Example 15, the subject matter of Example 14 includes, wherein the instructions further cause the processor to convert a text string in the third text message to a tag, and output the tag for display in the chat portion of the video conferencing meeting.

In Example 16, the subject matter of Examples 11-15 includes, wherein to associate the user device to the chat portion, the processor is caused to output an indicator for display, in a user interface corresponding to the video conferencing meeting, the indicator identifying that the user device can receive text messages via the chat portion.

In Example 17, the subject matter of Examples 11-16 includes, wherein the chat message includes an emoji, a file, or an image, and further comprising, sending the emoji, the file, or the image to the user device.

In Example 18, the subject matter of Examples 11-17 includes, wherein the instructions further cause the processor to receive a subsequent text message from the user device requesting that the chat messages stop, and in response, stop sending future chat messages received in the chat portion of the video conferencing meeting.

In Example 19, the subject matter of Examples 11-18 includes, wherein the text message is sent from the user device automatically when the user device is connected to the video conferencing meeting via the audio connection.

Example 20 is an apparatus for connecting a caller to an online chat function of a meeting via text messaging, the apparatus comprising: means for receiving, at a server via a gateway server, a text message from a user device, the text message including a meeting identifier; means for identifying, at the server, a video conferencing meeting corresponding to the meeting identifier; means for determining that the user device is connected to the video conferencing meeting via an audio connection; means for associating the user device to a chat portion of the video conferencing meeting based on the text message, the meeting identifier, and the audio connection; means for receiving, at the server from a chat service, a chat message in the chat portion of the video conferencing meeting; and means for sending, from the server via the gateway server, a second text message, including the chat message, to the user device.

Example 21 is a method for connecting a caller to an online chat function of a meeting via text messaging, the method comprising: identifying, at a server, a user device connected to an online conferencing meeting via an audio connection, the online conferencing meeting including a chat portion, and the audio connection being unable to access the chat portion included in the online conferencing meeting; automatically determining, based on identifying the user device and the audio connection, a chat setting for the user device, the chat setting including a text service separate from the online conferencing meeting, the text service configured to receive text messages from the user device; associating the user device to the chat portion of the online conferencing meeting by configuring chat messages received in the chat portion to be sent via the text service, separate from the online conferencing meeting; receiving, at the server from a chat service, a chat message in the chat portion of the online conferencing meeting; and sending, from the server via the text service, a text message including the chat message to the user device.

In Example 22, the subject matter of Example 21 includes, wherein the chat setting is configured by a user of the user device or by a host of the online conferencing meeting.

In Example 23, the subject matter of Examples 21-22 includes, wherein associating the user device to the chat portion includes associating the user device in response to the user device connecting to the online conferencing meeting via the audio connection or in response to a user selection of a number on the user device during the audio connection.

In Example 24, the subject matter of Examples 21-23 includes, wherein the text service includes at least one of short message service (SMS) or Multimedia Messaging Service (MMS) over Public Switched Telephone Network (PSTN), a text messaging service provided via an app outside the online conferencing meeting, or a text message sent over Session Initiation Protocol (SIP).

In Example 25, the subject matter of Examples 21-24 includes, receiving a second text message from the user device, and in response, propagating text from the second text message to the chat portion of the online conferencing meeting.

In Example 26, the subject matter of Example 25 includes, causing the text from the second text message to be displayed in a user interface implementation of the chat portion on an attendee device that is connected to the chat portion of the online conferencing meeting.

In Example 27, the subject matter of Examples 25-26 includes, converting a text string in the second text message to a tag, and displaying the tag in the chat portion of the online conferencing meeting.

In Example 28, the subject matter of Examples 21-27 includes, wherein the chat message includes an emoji, a file, or an image, and further comprising, sending the emoji, the file, or the image to the user device in the text message.

In Example 29, the subject matter of Examples 21-28 includes, receiving a subsequent text message from the user device requesting the chat messages stop, and in response, stopping sending future chat messages received in the chat portion of the online conferencing meeting.

In Example 30, the subject matter of Examples 21-29 includes, wherein the text message is sent to the user device using a phone number, and wherein the phone number is used for the audio connection.

In Example 31, the subject matter of Examples 21-30 includes, wherein associating the user device to the chat portion includes displaying an indicator, in a user interface corresponding to the online conferencing meeting, identifying the user device can receive text messages via the chat portion.

Example 32 is a system for connecting a caller to an online chat function of a meeting via text messaging, the system comprising: a processor of a server; and memory of the server, the memory including instructions, which when executed by the processor, cause the processor to: identify a user device connected to an online conferencing meeting via an audio connection, the online conferencing meeting including a chat portion, and the audio connection being unable to access the chat portion included in the online conferencing meeting; automatically determine, based on identifying the user device and the audio connection, a chat setting for the user device, the chat setting including a text service separate from the online conferencing meeting, the text service configured to receive text messages from the user device; associate the user device to the chat portion of the online conferencing meeting by configuring chat messages received in the chat portion to be sent via the text service, separate from the online conferencing meeting; receive, from a chat service, a chat message in the chat portion of the online conferencing meeting; and send a text message via the text service to the user device, the text message including the chat message.

In Example 33, the subject matter of Example 32 includes, wherein the chat setting is configured by a user of the user device or by a host of the online conferencing meeting.

In Example 34, the subject matter of Examples 32-33 includes, wherein associating the user device to the chat portion includes associating the user device in response to the user device connecting to the online conferencing meeting via the audio connection or in response to a user selection of a number on the user device during the audio connection.

In Example 35, the subject matter of Examples 32-34 includes, wherein the text service includes at least one of short message service (SMS) or Multimedia Messaging Service (MMS) over Public Switched Telephone Network (PSTN), a text messaging service provided via an app outside the online conferencing meeting, or a text message sent over Session Initiation Protocol (SIP).

In Example 36, the subject matter of Examples 32-35 includes, wherein the instructions further cause the processor to receive a second text message from the user device, and in response, propagate text from the second text message to the chat portion of the online conferencing meeting.

In Example 37, the subject matter of Example 36 includes, wherein the instructions further cause the processor to convert a text string in the second text message to a tag, and output the tag for display in the chat portion of the online conferencing meeting.

In Example 38, the subject matter of Examples 32-37 includes, wherein the chat message includes an emoji, a file, or an image, and further comprising, sending the emoji, the file, or the image to the user device in the text message.

In Example 39, the subject matter of Examples 32-38 includes, wherein the instructions further cause the processor to receive a subsequent text message from the user device requesting the chat messages stop, and in response, stop sending future chat messages received in the chat portion of the online conferencing meeting.

Example 40 is an apparatus for connecting a caller to an online chat function of a meeting via text messaging, the apparatus comprising: means for identifying a user device connected to an online conferencing meeting via an audio connection, the online conferencing meeting including a chat portion, and the audio connection being unable to access the chat portion included in the online conferencing meeting; means for automatically determining, based on identifying the user device and the audio connection, a chat setting for the user device, the chat setting including a text service separate from the online conferencing meeting, the text service configured to receive text messages from the user device; means for associating the user device to the chat portion of the online conferencing meeting by configuring chat messages received in the chat portion to be sent in text messages via the text service, separate from the online conferencing meeting; means for receiving, from a chat service, a chat message in the chat portion of the online conferencing meeting; and means for sending, via the text service, a text message including the chat message to the user device.

Example 41 is at least one machine-readable medium including instructions that, when executed by processing circuitry, cause the processing circuitry to perform operations to implement of any of Examples 1-40.

Example 42 is an apparatus comprising means to implement of any of Examples 1-40.

Example 43 is a system to implement of any of Examples 1-40.

Example 44 is a method to implement of any of Examples 1-40.

What is claimed is:

1. A method for connecting a caller to an online chat function of a meeting via text messaging, the method comprising:
identifying, at a server, a user device connected to an online conferencing meeting via an audio connection, the online conferencing meeting including a chat portion, and the audio connection being unable to access the chat portion included in the online conferencing meeting;
automatically determining, based on identifying the user device and the audio connection, a chat setting for the user device, the chat setting including a text service separate from the online conferencing meeting, the text service configured to receive text messages from the user device;
associating the user device to the chat portion of the online conferencing meeting by configuring chat messages received in the chat portion to be sent via the text service, separate from the online conferencing meeting;
receiving, at the server from a chat service, a chat message in the chat portion of the online conferencing meeting; and
sending, from the server via the text service, a text message including the chat message to the user device.

2. The method of claim 1, wherein the chat setting is configured by a user of the user device or by a host of the online conferencing meeting.

3. The method of claim 1, wherein associating the user device to the chat portion includes associating the user device in response to the user device connecting to the online conferencing meeting via the audio connection or in response to a user selection of a number on the user device during the audio connection.

4. The method of claim 1, wherein the text service includes at least one of short message service (SMS) or Multimedia Messaging Service (MMS) over Public Switched Telephone Network (PSTN), a text messaging service provided via an app outside the online conferencing meeting, or a text message sent over Session Initiation Protocol (SIP).

5. The method of claim 1, further comprising receiving a second text message from the user device, and in response, propagating text from the second text message to the chat portion of the online conferencing meeting.

6. The method of claim 5, further comprising causing the text from the second text message to be displayed in a user interface implementation of the chat portion on an attendee device that is connected to the chat portion of the online conferencing meeting.

7. The method of claim 5, further comprising converting a text string in the second text message to a tag, and displaying the tag in the chat portion of the online conferencing meeting.

8. The method of claim 1, wherein the chat message includes an emoji, a file, or an image, and further comprising, sending the emoji, the file, or the image to the user device in the text message.

9. The method of claim 1, further comprising receiving a subsequent text message from the user device requesting the chat messages stop, and in response, stopping sending future chat messages received in the chat portion of the online conferencing meeting.

10. The method of claim 1, wherein the text message is sent to the user device using a phone number, and wherein the phone number is used for the audio connection.

11. The method of claim 1, wherein associating the user device to the chat portion includes displaying an indicator, in a user interface corresponding to the online conferencing meeting, identifying the user device can receive text messages via the chat portion.

12. A system for connecting a caller to an online chat function of a meeting via text messaging, the system comprising:
a processor of a server; and
memory of the server, the memory including instructions, which when executed by the processor, cause the processor to:
identify a user device connected to an online conferencing meeting via an audio connection, the online conferencing meeting including a chat portion, and the audio connection being unable to access the chat portion included in the online conferencing meeting;
automatically determine, based on identifying the user device and the audio connection, a chat setting for the user device, the chat setting including a text service separate from the online conferencing meeting, the text service configured to receive text messages from the user device;
associate the user device to the chat portion of the online conferencing meeting by configuring chat messages received in the chat portion to be sent via the text service, separate from the online conferencing meeting;
receive, from a chat service, a chat message in the chat portion of the online conferencing meeting; and
send a text message via the text service to the user device, the text message including the chat message.

13. The system of claim 12, wherein the chat setting is configured by a user of the user device or by a host of the online conferencing meeting.

14. The system of claim 12, wherein associating the user device to the chat portion includes associating the user device in response to the user device connecting to the online conferencing meeting via the audio connection or in response to a user selection of a number on the user device during the audio connection.

15. The system of claim 12, wherein the text service includes at least one of short message service (SMS) or Multimedia Messaging Service (MMS) over Public Switched Telephone Network (PSTN), a text messaging service provided via an app outside the online conferencing meeting, or a text message sent over Session Initiation Protocol (SIP).

16. The system of claim 12, wherein the instructions further cause the processor to receive a second text message from the user device, and in response, propagate text from the second text message to the chat portion of the online conferencing meeting.

17. The system of claim 16, wherein the instructions further cause the processor to convert a text string in the second text message to a tag, and output the tag for display in the chat portion of the online conferencing meeting.

18. The system of claim 12, wherein the chat message includes an emoji, a file, or an image, and further comprising, sending the emoji, the file, or the image to the user device in the text message.

19. The system of claim 12, wherein the instructions further cause the processor to receive a subsequent text message from the user device requesting the chat messages stop, and in response, stop sending future chat messages received in the chat portion of the online conferencing meeting.

20. An apparatus for connecting a caller to an online chat function of a meeting via text messaging, the apparatus comprising:
means for identifying a user device connected to an online conferencing meeting via an audio connection, the online conferencing meeting including a chat portion, and the audio connection being unable to access the chat portion included in the online conferencing meeting;
means for automatically determining, based on identifying the user device and the audio connection, a chat setting for the user device, the chat setting including a text service separate from the online conferencing meeting, the text service configured to receive text messages from the user device;
means for associating the user device to the chat portion of the online conferencing meeting by configuring chat messages received in the chat portion to be sent in text messages via the text service, separate from the online conferencing meeting;
means for receiving, from a chat service, a chat message in the chat portion of the online conferencing meeting; and
means for sending, via the text service, a text message including the chat message to the user device.
